(19) United States
(12) Patent Application Publication
(10) Pub. No.: US 2006/0223515 A1
(43) Pub. Date: Oct. 5, 2006

(54) SNMP management in a software defined radio

(75) Inventors: Michael J. Hermel, Waseca, MN (US); Santosh K. Sonbarse, Eden Prairie, MN (US); William J. Mitchell, Eden Prairie, MN (US); Douglas D. Weaver, Plymouth, MN (US)

Correspondence Address: FOGG AND ASSOCIATES, LLC, P.O. BOX 581339, MINNEAPOLIS, MN, 55458-1339, US

(73) Assignee: ADC Telecommunications, Inc., Eden Prairie, MN (US)

(21) Appl. No.: 11/095,111

(22) Filed: Mar. 31, 2005

(51) Int. Cl. H04B 1/38

(52) U.S. Cl. 455/418

(57) ABSTRACT

A communications system is presented. One or more radio head units are adapted to receive radio signals through one or more radio antennas and adapted to communicate voice and data streams to one or more radio head interface modules. The one or more radio head interface modules are adapted to communicate with a call processing software module wherein the call processing software module performs modulation and demodulation of voice and data streams using one or more air interface standards. An element management system module is adapted to alter one or more operating parameters of the one or more radio head interface modules and an SNMP agent module adapted to communicate with the element management system. The SNMP agent module is further adapted to alter one or more operating parameters of the one or more radio head interface modules based on write commands from an SNMP management module.

### CROSS REFERENCES TO RELATED APPLICATIONS

This application is related to the following co-pending U.S. patent applications filed on even date herewith, all of which are hereby incorporated herein by reference:

U.S. patent application Ser. No. ______ (attorney docket number 100.672US01 entitled “DYNAMIC FREQUENCY HOPPING”) and which is referred to here as the '672 Application;

U.S. patent application Ser. No. ______ (attorney docket number 100.673US01 entitled “DYNAMIC DIGITAL UP AND DOWN CONVERTERS”) and which is referred to here as the '673 Application;

U.S. patent application Ser. No. ______ (attorney docket number 100.675US01 entitled “DYNAMIC RECONFIGURATION OF RESOURCES THROUGH PAGE HEADERS”) and which is referred to here as the '675 Application;

U.S. patent application Ser. No. ______ (attorney docket number 100.676US01 entitled “SIGNAL ENHANCEMENT THROUGH DIVERSITY”) and which is referred to here as the '676 Application;

U.S. patent application Ser. No. ______ (attorney docket number 100.678US01 entitled “TIME STAMP IN THE REVERSE PATH”) and which is referred to here as the '678 Application;

U.S. patent application Ser. No. ______ (attorney docket number 100.679US01 entitled “BUFFERS HANDLING MULTIPLE PROTOCOLS”) and which is referred to here as the '679 Application;

U.S. patent application Ser. No. ______ (attorney docket number 100.680US01 entitled “TIME START IN THE FORWARD PATH”) and which is referred to here as the '680 Application;

U.S. patent application Ser. No. ______ (attorney docket number 100.681US01 entitled “LOSS OF PAGE SYNCHRONIZATION”) and which is referred to here as the '681 Application;

U.S. patent application Ser. No. ______ (attorney docket number 100.684US01, entitled “DYNAMIC REALLOCATION OF BANDWIDTH AND MODULATION PROTOCOLS” and which is referred to here as the '684 Application;

U.S. patent application Ser. No. ______ (attorney docket number 100.685US01 entitled “DYNAMIC READJUSTMENT OF POWER”) and which is referred to here as the '685 Application;

U.S. patent application Ser. No. ______ (attorney docket number 100.686US01 entitled “METHODS AND SYSTEMS FOR HANDLING UNDERFLOW AND OVERFLOW IN A SOFTWARE DEFINED RADIO”) and which is referred to here as the '686 Application; and

U.S. patent application Ser. No. ______ (attorney docket number 100.700US01 entitled “INTEGRATED NETWORK MANAGEMENT OF A SOFTWARE DEFINED RADIO SYSTEM”) and which is referred to here as the '700 Application.

### TECHNICAL FIELD

The following description relates to communication systems and in particular to wireless communication systems.

### BACKGROUND

Many changes are taking place in the way wireless communication networks are being deployed. Some of the changes are being driven by the adoption of new mobile communications standards. The introduction of software defined radios to wireless telecommunications has led to the generation of software and hardware solutions to meet the new standards. Current mobile communication standards introduce physical and logical channels and pose new issues in the transport of information within the communication networks.

A software defined radio (SDR) uses software for the modulation and demodulation of radio signals. The use of reprogrammable software allows key radio parameters, such as frequency and modulation protocols to be modified without the need to alter the underlying hardware of the system. Additionally, SDRs allow a single device to support multiple configurations which previously would have required multiple hardware devices. One example of a software defined radio is the Vanu Software Radio produced by Vanu, Inc. (See U.S. Pat. No. 6,654,428).

Some modulation standards that wireless communication networks operate with include, but are not limited to, Advanced Mobile Phone System (AMPS), code division multiple access (CDMA), Wide-band CDMA (WCDMA), time division multiple access (TDMA), Global System for Mobile communications (GSM), Cellular Digital Packet Data (CDPD), Enhanced Data rates for GSM Evolution (EDGE), General Packet Radio Service (GPRS), Integrated Digital Enhanced Network (iDEN), and Orthogonal Frequency Division Multiplexing (OFDM).

The emergence of reconfigurable software defined radio networks allows the network owners and operators to offer a wide range of communication service that can be reconfigured as customer needs change.

For the reasons stated above, and for other reasons stated below that will become apparent to those skilled in the art upon reading and understanding the present specification, there is a need in the art today for more efficient methods and systems to control and coordinate the configurations of components comprising software defined radio networks.

### SUMMARY

Embodiments of the present invention address the problem of handling buffer underflows and overflows, as well as other problems and will be understood by reading and studying the following specification.

In one embodiment, a communications system is provided. The system comprises one or more radio head interface modules, one or more radio head units adapted to receive radio signals through one or more radio antennas and adapted to communicate voice and data streams to the one or more radio head interface modules, and a call processing software module. The one or more radio head interface modules are adapted to communicate with the call processing software module. The call processing software module performs modulation and demodulation of the voice and data streams using one or more air interface standards. The system further comprises an element management system module adapted to alter one or more operating parameters of the one or more radio head interface modules.

In another embodiment, a method of configuring networked devices for a software defined radio is provided. The method comprises receiving radio signals through one or more radio antennas; communicating voice and data streams to one or more radio head interface modules; communicating with a call processing software module; performing modulation and demodulation of the voice and data streams using one or more air interface standards; sending one or more SNMP commands; and altering one or more operating parameters of the one or more radio head interface modules.

In yet another embodiment, a computer-readable medium having computer-executable instructions for configuring networked devices for a software defined radio communications network is provided. The method comprises modulating and demodulating digital voice and data streams using one or more air interface standards, receiving one or more SNMP commands, and altering one or more logical channel RF parameters.

In still yet another embodiment a communications system is disclosed. The system comprises means for modulating and demodulating digital voice and data streams using one or more air interface standard, means for communicating SNMP commands, and means for altering one or more operating parameters of one or more radio head interface modules based on SNMP commands.

### DRAWINGS

Embodiments of the present invention are more easily understood and further advantages and uses thereof more readily apparent, when considered in view of the description of the preferred embodiments and the following figures in which:

FIG. 1A is a block diagram of one embodiment of a communications system.

FIG. 1B is a block diagram of one embodiment of a radio head interface module.

FIG. 1C is a block diagram of one embodiment of a base station server.

FIG. 1D is a block diagram of one embodiment of a communications system.

FIG. 2 is a flow chart of one embodiment a method for configuring networked devices for a software defined radio communications network.

In accordance with common practice, the various described features are not drawn to scale but are drawn to emphasize features relevant to the present invention. Reference characters denote like elements throughout Figures and text.

### DETAILED DESCRIPTION

In the following detailed description, reference is made to the accompanying drawings that form a part hereof, and in which is shown by way of illustration specific illustrative embodiments in which the invention may be practiced. These embodiments are described in sufficient detail to enable those skilled in the art to practice the invention, and it is to be understood that other embodiments may be utilized and that logical, mechanical and electrical changes may be made without departing from the spirit and scope of the present invention. The following detailed description is, therefore, not to be taken in a limiting sense.

Embodiments of the present invention concern portions of a software defined radio network that typically comprises cellular antennas, a radio head transmitting and receiving voice and/or data communications over the cellular antennas, and a base station (also commonly called a base transceiver station (BTS), or a server) that communicates voice and data signals between the radio head and a larger communication network (e.g. the public switched telephone network, or the Internet). In some embodiments, one or more base stations are connected to a base station controller (BSC) which controls data communication flow in one or more connected base stations. In some embodiments, the network further includes one or more message switching center (MSC) which controls the data communication flow through one or more BSC's. In one embodiment, the MSC functions to identify the closest BTS to a cellular device user and switches data communications for that device to the closest identified BTS.

In some embodiments, communications between a BTS and a remote unit take place through two sets of data. Typically, forward logical channels carry data from the BTS through the radio head to an end user device. Reverse logical channels carry data from end user devices through the radio head to the BTS. Each logical channel is assigned a radio frequency (RF) channel and a modulation protocol, which the communications network uses to wirelessly communicate data with individual cellular devices.

Embodiments of the present invention provide systems and methods for configuring multiple components of a software defined radio network using Simple Network Management Protocol (SNMP) agents and network-management systems (NMS).

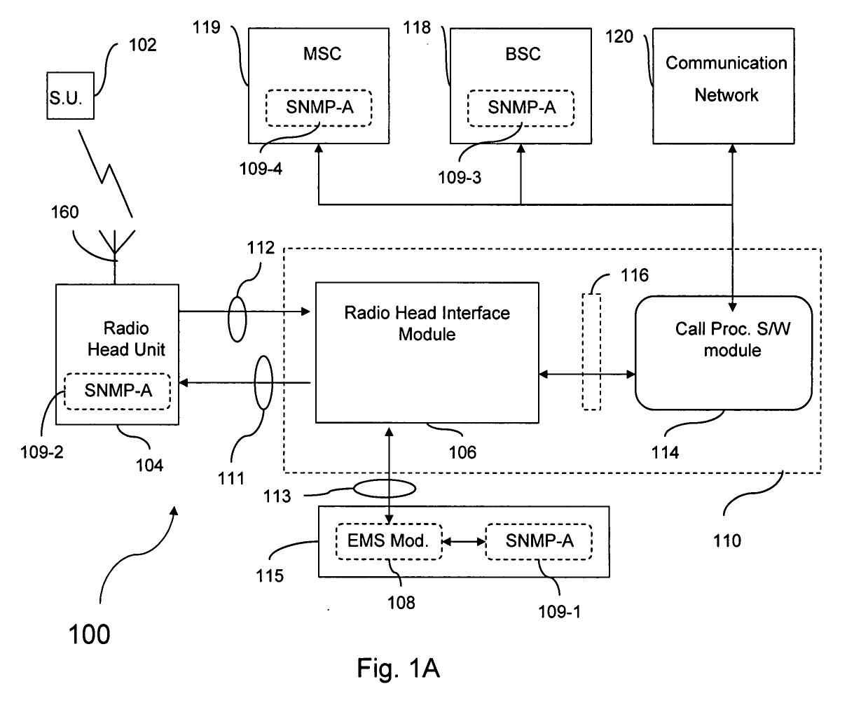

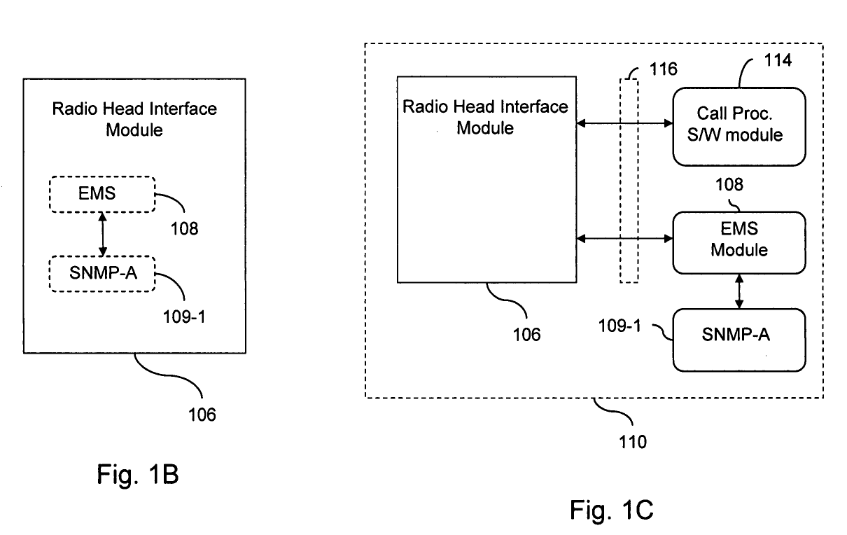

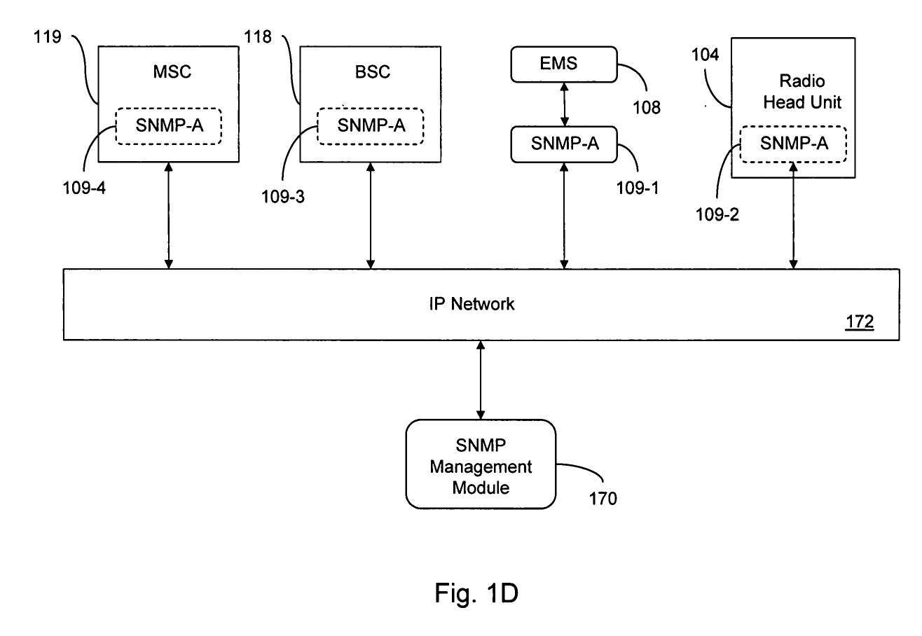

FIG. 1A provides a block diagram of one embodiment of a software defined radio communication system shown generally at 100. Communication system 100 includes one or more subscriber units 102 (or mobile devices 102) within a service area of a radio head unit 104. Radio head unit 104 is coupled to one or more servers 110 (or BTS 110) over one or more transport mediums 111, and 112. BTS 110 is connected to one or more communication networks 120 (e.g. public switched telephone network (PSTN), Internet, a cable network, or the like). In one embodiment, BTS 110 is connected to one or more communication networks through a base station controller (BSC) 118. In another embodiment, BSC 118 is further coupled to a mobile switching center (MSC) 122. Cellular antennas 160, adapted for receiving cellular signals from one or more subscriber units 102, are coupled to radio head unit 104. In one embodiment, network 100 is a bidirectional network and as shown includes equipment for forward links (i.e. transmissions on forward logical channels from communications network 120 to mobile device 102) and reverse links (i.e. transmissions on reverse logical channels from mobile device 102 to communications network 120). BTS 110 includes a call processing software module 114 (or call processing software 114) that interfaces with one or more communication networks 120. Call processing software module 114 also includes programming which implements a SDR with the BTS 110 and radio head unit 104 hardware, digitally performing waveform processing to modulate and demodulate radio signals transmitted and received, respectively, from the cellular antennas 160. In one embodiment, call processing software module 114 is a Vanu, Inc., Vanu Software Radio.

In one embodiment, BTS 110 and call processing software module 114 communicate with radio head unit 104 through a radio head interface module 106 (or radio head interface 106). Radio head interface 106 establishes high speed digital communication paths for two or more sets of base band data stream logical channels (i.e. forward logical channels, reverse logical channels and diversity channels) and all communication between BTS 1 10 and radio head unit 104 goes through radio head interface 106.

Radio head interface module 106, radio head unit 104, and call processing software module 114, all handle multiple types of modulation protocols, and in different embodiments, one or more of the logical channels transmit data using a different modulation protocol than another logical channel. In one embodiment, radio head interface module 106, radio head unit 104, and call processing software module 114, handle modulation protocols for one or more of, but not limited to, Advanced Mobile Phone System (AMPS), code division multiple access (CDMA), Wide-band CDMA (WCDMA), time division multiple access (TDMA), Global System for Mobile communications (GSM), Cellular Digital Packet Data (CDPD), Enhanced Data rates for GSM Evolution (EDGE), General Packet Radio Service (GPRS), Integrated Digital Enhanced Network (iDEN), Orthogonal Frequency Division Multiplexing (OFDM), or any other appropriate modulation protocol. A modulation protocol is commonly also referred to as an air interface standard, a modulation standard, an air interface protocol, or an air interface modulation protocol. For each logical channel, call processing software module 114 performs modulation and demodulation of forward and reverse logical channel voice data streams using one or more of the air interface standard protocols. In one embodiment, the forward and reverse logical channel data streams carry complex RF data samples representing voice and data communications.

Element management system (EMS) module 108 provides a software interface which allows a network owner to initialize and configure radio head interface module 106 operating configurations such as, but not limited to: enabling and disabling of specific logical channels; load digital up converter and digital down converter filter parameters and sample rates associated with supported modulation protocols; specifying modulation protocol, RF channels, bandwidth allocations, and signal gain for specific logical channels; enabling and disabling call processing software module 114 ability to reconfigure the operating parameters of specific logical channels (such as frequency hopping, bandwidth allocation, channel signal gain, and modulation protocol); changing the page length for complex RF data sample pages and redefining the expected start of page indicator; enabling and disable page synchronization functions; enable and disable buffer underflow and overflow functions. Further information pertaining to digital up converters and down converters is provided in the '673 Application herein incorporated by reference. Additional information pertaining to configuring modulation protocols, RF frequencies, bandwidth allocations and signal gains for logical channels in a software defined radio are provided in the '672, '684, '685 and '675 Applications, herein incorporated by reference. Additional information pertaining to the reconfiguration of radio head interface module 106 by call processing software module 114 are provided in the '672, '684, '685, '675 and '676 Applications, herein incorporated by reference. Additional information pertaining to complex RF data sample pages, synchronization functions, and buffer underflow and overflow functions are provided in the '675, '681 and '686 Applications herein incorporated by reference.

In one embodiment, EMS module 108 comprises a software application running on a remote computer system 115 external to BTS 110 and EMS module 108 and radio head interface module 106 are both adapted to communicate with each other over link 113. In other embodiments, EMS module 108 is located within radio head interface module 106 as illustrated in FIG. 1B. In one embodiment, radio head interface module 106 is further adapted with one or more input/output ports which provide access to EMS module 108. In one embodiment, radio head interface module 106 is coupled to BTS 110 through an interface device 116. In one embodiment, interface device 116 is one of, but not limited to a PCI-X interface, an ATCA interface, a PCI Express interface, a Gigabit Ethernet interface, a SCSI interface, a Rocket I/O interface, a UDP/IP link interface, a TCP/IP link interface, a Serial ATA interface, a Card bus for PCMIA card interface, a high speed serial interface or a high speed parallel interface. In one embodiment, EMS module 108 is located within BTS 110 and is adapted to communicate to radio head interface module 106 through interface device 116 as illustrated in FIG. 1C.

In one embodiment, EMS module 108 is further adapted with an SNMP agent 109-1 that accepts read and write commands from SNMP management module 170. SNMP is a protocol that facilitates the exchange of information between devices over networks supporting TCP/IP. SNMP enables networked devices that store information related to network management to communicate that information to SNMP management applications, such as SNMP management module 170. An SNMP agent, such as SNMP agent 109-1, is a software module resident on the network device that translates information stored within the networked device into a form that can be communicated with the SNMP management applications. SNMP management applications can further issue commands to SNMP agents in order to control the networked device.

In one embodiment, SNMP management module 170 issues read commands to SNMP agent 109-1 to examine the current state of the operating configurations for radio head interface module 106. In one embodiment, SNMP management module 170 issues write commands to SNMP agent 109-1 which allow SNMP management module 170 to configure one or more radio head interface module 106 operating configurations including, but not limited to: enabling and disabling of specific logical channels; load digital up converter and digital down converter filter parameters and sample rates associated with supported modulation protocols; specifying modulation protocol, RF channels, bandwidth allocations, and signal gain for specific logical channels; enabling and disabling call processing software module 114 ability to reconfigure the operating parameters of specific logical channels (such as frequency hopping, bandwidth allocation, channel signal gain, and modulation protocol); changing the page length for complex RF data sample pages and redefining the expected start of page indicator; enabling and disable page synchronization functions; enable and disable buffer underflow and overflow functions.

In one embodiment, radio head unit 104 is adapted with an SNMP agent 109-2 that accepts read and write commands from SNMP management module 170. In one embodiment, SNMP management module 170 issues read commands to SNMP agent 109-2 to examine the current state of the operating configuration for radio head unit 104. In one embodiment, SNMP management module 170 reconfigures high speed communications media 111 and 112 by sending commands to one or both of SNMP agent 109-1 and SNMP agent 109-2. In one embodiment, high speed communications media 111 and 112 are each comprised of a plurality of fiber optic data paths. SNMP management module 170 instructs one or both of SNMP agent 109-1 and SNMP agent 109-2 to change the fiber paths used to communicate complex RF data samples between radio head unit 104 and radio head interface module 106.

In one embodiment, BSC 118 is adapted with an SNMP agent 109-3 that accepts read and write commands from SNMP management module 170. In one embodiment, MSC 119 is adapted with an SNMP agent 109-4 that accepts read and write commands from SNMP management module 170.

In one embodiment, SNMP management module 170 communicates with one or more of SNMP agents 109-1 to 109-4 via an Internet Protocol network such as IP Network 172. In one embodiment, SNMP management module 170 communicates with one or more of SNMP agents 109-1 to 109-4 through communications network 120. In one embodiment, SNMP management module 170 further communicates with SNMP agent 109-2 via high speed communications media 111 and 112.

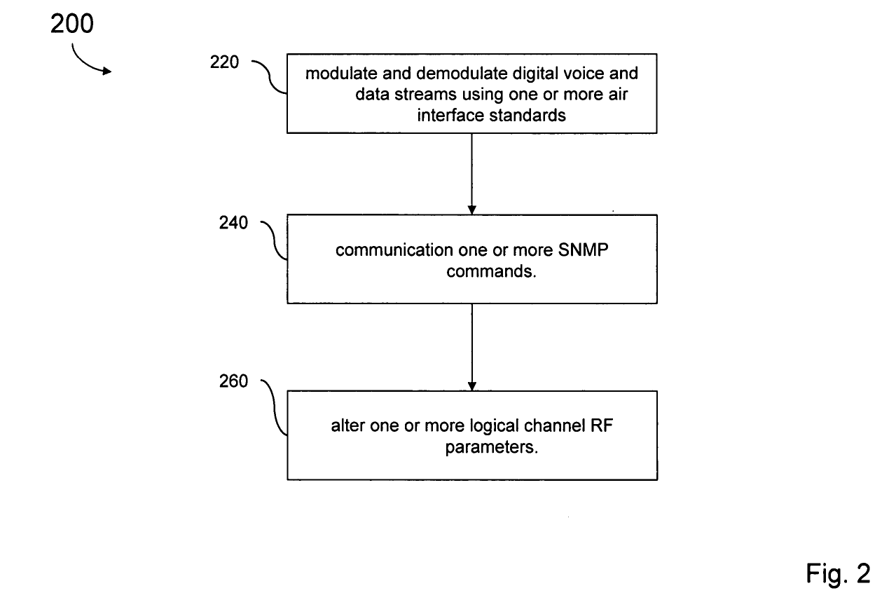

FIG. 2 is a flowchart illustrating a method for configuring networked devices for a software defined radio communications network. The method comprises modulating and demodulating digital voice and data streams using one or more air interface standards (220); sending one or more SNMP commands (240); and altering one or more logical channel RF parameters (260) based on the SNMP commands.

Several ways are available to implement the radio head interface module, SNMP agent module, SNMP management module, and server elements of the current invention. These include, but are not limited to, digital computer systems, programmable controllers, or field programmable gate arrays. Therefore other embodiments of the present invention are the program instructions resident on computer readable media which when implemented by such controllers, enable the controllers to implement embodiments of the present invention. Computer readable media include any form of computer memory, including but not limited to punch cards, magnetic disk or tape, any optical data storage system, flash ROM, non-volatile ROM, PROM, E-PROM or RAM, or any other form of permanent, semi-permanent, or temporary memory storage system or device.

Although specific embodiments have been illustrated and described herein, it will be appreciated by those of ordinary skill in the art that any arrangement, which is calculated to achieve the same purpose, may be substituted for the specific embodiment shown. This application is intended to cover any adaptations or variations of the present invention. Therefore, it is manifestly intended that this invention be limited only by the claims and the equivalents thereof.

What is claimed is:

1. A communications system, the system comprising:
one or more radio head interface modules;
one or more radio head units adapted to receive radio signals through one or more radio antennas and adapted to communicate voice and data streams to the one or more radio head interface modules;
a call processing software module, the one or more radio head interface modules adapted to communicate with the call processing software module;
wherein the call processing software module performs modulation and demodulation of the voice and data streams using one or more air interface standards; and
an element management system module adapted to alter one or more operating parameters of the one or more radio head interface modules.

2. The system of claim 1, wherein the one or more air interface protocols include at least one of Global System for Mobile communications (GSM), Advanced Mobile Phone System (AMPS), code division multiple access (CDMA), Wide-band CDMA, time division multiple access (TDMA), Cellular Digital Packet Data (CDPD), Enhanced Data rates for GSM Evolution (EDGE), General Packet Radio Service (GPRS), Integrated Digital Enhanced Network (iDEN), and Orthogonal Frequency Division Multiplexing (OFDM).

3. The system of claim 1, further comprising:
an SNMP agent module adapted to communicate with the element management system; and
an SNMP management module adapted to communicate with the SNMP agent module;
wherein the SNMP agent module is further adapted to receive read commands from the SNMP management module and provide the current state of the one or more operating parameters of the one or more radio head interface modules;
wherein the SNMP agent module is further adapted to receive write commands from the SNMP management module and alter one or more operating parameters of the one or more radio head interface modules based on the write commands.

4. The system of claim 3, wherein the one or more operating parameters include one or more of:
enablement and disablement of logical channels;
enablement and disablement of page synchronization functions;
enablement and disablement of buffer underflow and overflow functions;
digital up converter filter parameters, digital down converter filter parameters and sample rates associated with the one or more air interface protocols;
logical channel RF parameters for one or more forward, reverse and diversity logical channels;
page length for complex RF data sample pages;
start of page indicator; and
enablement and disablement of call processing software logical channel reconfiguration instructions.

5. The system of claim 4, wherein call processing software logical channel reconfiguration instructions include one or more of:
frequency hopping instructions;
bandwidth allocation instructions;
protocol reconfiguration instructions; and
signal gain adjustment instructions.

6. The system of claim 4, wherein the logical channel RF parameters include one or more of modulation protocol, radio frequency, bandwidth allocation, and signal gain.

7. The system of claim 3, further comprising:
a remote computer system, wherein the SNMP agent module and the element management system module are software applications on the remote computer system.

8. The system of claim 1, further comprising:
one or more interface devices, wherein the one or more radio head interface modules communicate with the call processing software module over the one or more interface devices.

9. The system of claim 8, wherein the one or more interface devices includes at least one of a PCI-X interface, an ATCA interface, a PCI Express interface, a Gigabit Ethernet interface, a SCSI interface, a Rocket I/O interface, a UDP/IP link interface, a TCP/IP link interface, a Serial ATA interface, a Card bus for PCMIA card interface, a high speed serial interface and a high speed parallel interface.

10. The system of claim 8, wherein the element management system communicates with the one or more radio head interface modules over the one or more interface devices.

11. The system of claim 10, further comprising:
an SNMP agent module adapted to communicate with the element management system; and
an SNMP management module adapted to communicate with the SNMP agent module;
wherein the SNMP agent module is further adapted to receive read commands from the SNMP management module and provide the current state of one or more operating parameters of the one or more radio head interface modules;
wherein the SNMP agent module is further adapted to receive write commands from the SNMP management module and alter one or more operating parameters of the one or more radio head interface modules based on the write commands.

12. The system of claim 11, wherein the one or more operating parameters include one or more of:
enablement and disablement of logical channels;
enablement and disablement of page synchronization functions;
enablement and disablement of buffer underflow and overflow functions;
digital up converter filter parameters, digital down converter filter parameters and sample rates associated with the one or more air interface protocols;
logical channel RF parameters for one or more forward, reverse and diversity logical channels;
page length for complex RF data sample pages;
start of page indicator; and
enablement and disablement of call processing software logical channel reconfiguration instructions.

13. The system of claim 12, wherein call processing software logical channel reconfiguration instructions include one or more of:
frequency hopping instructions;
bandwidth allocation instructions;
protocol reconfiguration instructions; and
signal gain adjustment instructions.

14. The system of claim 12, wherein the logical channel RF parameters include one or more of modulation protocol, radio frequency, bandwidth allocation, and signal gain.

15. The system of claim 1, further comprising:
a base station controller;
a master switching center;
one or more SNMP agent modules adapted to communicate with and reconfigure one or more of: the element management system, the radio head unit, the base station controller, the master switching center; and
an SNMP management module adapted to communicate with the one or more SNMP agent modules.

16. The system of claim 15, further comprising:
one or more high speed transport mediums;
wherein a first SNMP agent of the one or more SNMP agent modules is further adapted to receive read commands from the SNMP management module and provide the current state of one or more operating parameters of the one or more radio head interface modules;
wherein the first SNMP agent module is further adapted to receive write commands from the SNMP management module and alter one or more operating parameters of the one or more radio head interface modules based on the write commands.

17. The system of claim 16, wherein the one or more operating parameters include one or more of:
enablement and disablement of logical channels;
enablement and disablement of page synchronization functions;
enablement and disablement of buffer underflow and overflow functions;
digital up converter filter parameters, digital down converter filter parameters and sample rates associated with the one or more air interface protocols;
logical channel RF parameters for one or more forward, reverse and diversity logical channels;
page length for complex RF data sample pages;
start of page indicator; and
enablement and disablement call processing software logical channel reconfiguration instructions.

18. The system of claim 17, wherein call processing software logical channel reconfiguration instructions include one or more of:
frequency hopping instructions;
bandwidth allocation instructions;
protocol reconfiguration instructions; and
signal gain adjustment instructions.

19. The system of claim 17, wherein the logical channel RF parameters include one or more of modulation protocol, radio frequency, bandwidth allocation, and signal gain.

20. The system of claim 15, wherein a second SNMP agent module of the one or more SNMP agent modules is further adapted to receive read commands from the SNMP management module and provide the current state of one or more operating parameters of a first radio head unit of the one or more radio head units, wherein the second SNMP agent module is further adapted to receive write commands from the SNMP management module and alter one or more operating parameters of the first radio head unit based on the write commands.

21. The system of claim 20, further comprising:
one or more high speed transport mediums, wherein the one or more radio head units communicate the voice and data streams to the one or more radio head interface modules through the one or more high speed transport mediums;
wherein the SNMP management module is further adapted to reconfigure the one or more high speed transport mediums.

22. A software defined radio communications network system, the system comprising:
at least one radio head unit adapted with an SNMP agent module;
at least one radio head interface module adapted with an SNMP agent module;
at least one call processing software module; and
an SNMP management module.

23. The system of claim 22, wherein the SNMP management module is adapted to obtain the current state of one or more operating parameters of the at least one radio head interface module and the at least one radio head unit.

24. The system of claim 22, wherein the SNMP management module is adapted to alter one or more operating parameters of the at least one radio head interface module and the at least one radio head unit.

25. The system of claim 24, wherein the one or more operating parameters include one or more of:
enablement and disablement of individual forward, reverse and diversity logical channels;
enablement and disablement of page synchronization functions; and
enablement and disablement of buffer underflow and overflow functions digital up converter filter parameters, digital down converter filter parameters and sample rates associated with one or more air interface protocols;
logical channel RF parameters for one or more forward, reverse and diversity logical channels;
page length for complex RF data sample pages;
start of page indicator; and
enablement and disablement of call processing software logical channel reconfiguration instructions.

26. The system of claim 25, wherein call processing software logical channel reconfiguration instructions include one or more of:
frequency hopping instructions;
bandwidth allocation instructions;
protocol reconfiguration instructions; and
signal gain adjustment instructions.

27. The system of claim 25, wherein the logical channel RF parameters include one or more of modulation protocol, radio frequency, bandwidth allocation, and signal gain.

28. The system of claim 22 further comprising:
at least one base station controller adapted with an SNMP agent module; and
at least one master switching center adapted with an SNMP agent module.

29. The system of claim 28, wherein the SNMP management module is adapted to obtain the current state of one or more operating parameters of the at least one base station controller and the at least one master switching center.

30. The system of claim 29, wherein the SNMP management module is adapted to alter one or more operating parameters of the at least one base station controller and the at least one master switching center.

31. A method of configuring networked devices for a software defined radio communications network, the method comprising:
receiving radio signals through one or more radio antennas;
communicating voice and data streams to one or more radio head interface modules;
communicating with a call processing software module;
performing modulation and demodulation of the voice and data streams using one or more air interface standards;
sending one or more SNMP commands; and
altering one or more operating parameters of the one or more radio head interface modules.

32. A method for configuring networked devices for a software defined radio communications network, the method comprising:
modulating and demodulating digital voice and data streams using one or more air interface standards;
sending one or more SNMP commands; and
altering one or more logical channel RF parameters.

33. The method of claim 32, wherein the one or more logical channel RF parameters include one or more of modulation protocol, radio frequency, bandwidth allocation, and signal gain.

34. The method of claim 32, further comprising:
altering one or more network operating parameters.

35. The method of claim 34, wherein altering one or more network operating parameters further comprises one or more of:
enabling one or more logical channels;
disabling one or more logical channels;
enabling page synchronization for one or more logical channels;
disabling page synchronization functions for one or more logical channels;
enabling buffer underflow and overflow functions for one or more logical channels;
disabling buffer underflow and overflow functions for one or more logical channels;
enabling call processing software logical channel reconfiguration instructions for one or more logical channels;
disabling call processing software logical channel reconfiguration instructions for one or more logical channels;
configuring digital up converter filter parameters, digital down converter filter parameters and sampling rates associated with the one or more air interface protocols;
redefining a page length for complex RF data sample pages; and
redefining a start of page indicator.

36. The method of claim 35, wherein call processing software logical channel reconfiguration instructions include one or more of:
frequency hopping instructions;
bandwidth allocation instructions;
protocol reconfiguration instructions; and
signal gain adjustment instructions.

37. The method of claim 32, wherein the one or more air interface protocols include at least one of Global System for Mobile communications (GSM), Advanced Mobile Phone System (AMPS), code division multiple access (CDMA), Wide-band CDMA, time division multiple access (TDMA), Cellular Digital Packet Data (CDPD), Enhanced Data rates for GSM Evolution (EDGE), General Packet Radio Service (GPRS), Integrated Digital Enhanced Network (iDEN), and Orthogonal Frequency Division Multiplexing (OFDM).

38. A computer-readable medium having computer-executable instructions for a method for configuring networked devices for a software defined radio communications network, the method comprising:
modulating and demodulating digital voice and data streams using one or more air interface standards;
receiving one or more SNMP commands; and
altering one or more logical channel RF parameters.

39. The method of claim 38, wherein the one or more logical channel RF parameters include one or more of modulation protocol, radio frequency, bandwidth allocation, and signal gain.

40. The method of claim 38, further comprising:
altering one or more network operating parameters.

41. The method of claim 40, wherein altering one or more network operating parameters further comprises one or more of:
enabling one or more logical channels;
disabling one or more logical channels;
enabling page synchronization for one or more logical channels;
disabling page synchronization functions for one or more logical channels;
enabling buffer underflow and overflow functions for one or more logical channels;
disabling buffer underflow and overflow functions for one or more logical channels;
enabling call processing software logical channel reconfiguration instructions for one or more logical channels;
disabling call processing software logical channel reconfiguration instructions for one or more logical channels;
configuring digital up converter filter parameters, digital down converter filter parameters and sampling rates associated with the one or more air interface protocols;
redefining a page length for complex RF data sample pages; and
redefining a start of page indicator.

42. The method of claim 41, wherein call processing software logical channel reconfiguration instructions include one or more of:
frequency hopping instructions;
bandwidth allocation instructions;
protocol reconfiguration instructions; and
signal gain adjustment instructions.

43. The method of claim 38, wherein the one or more air interface protocols include at least one of Global System for Mobile communications (GSM), Advanced Mobile Phone System (AMPS), code division multiple access (CDMA), Wide-band CDMA, time division multiple access (TDMA), Cellular Digital Packet Data (CDPD), Enhanced Data rates for GSM Evolution (EDGE), General Packet Radio Service (GPRS), Integrated Digital Enhanced Network (iDEN), and Orthogonal Frequency Division Multiplexing (OFDM).

44. A communications system, the system comprising:
means for modulating and demodulating digital voice and data streams using one or more air interface standard;
means for communicating SNMP commands;
means for altering one or more operating parameters of one or more radio head interface modules based on SNMP commands.

45. The system of claim 44, wherein the one or more air interface protocols include at least one of Global System for Mobile communications (GSM), Advanced Mobile Phone System (AMPS), code division multiple access (CDMA), Wide-band CDMA, time division multiple access (TDMA), Cellular Digital Packet Data (CDPD), Enhanced Data rates for GSM Evolution (EDGE), General Packet Radio Service (GPRS), Integrated Digital Enhanced Network (iDEN), and Orthogonal Frequency Division Multiplexing (OFDM).

46. The system of claim 44, wherein the one or more operating parameters include one or more of:
enablement and disablement of logical channels;
enablement and disablement of a page synchronization function;
enablement and disablement of a buffer underflow and overflow function;
digital up converter filter parameters, digital down converter filter parameters and sample rates associated with the one or more air interface protocols;
logical channel RF parameters for one or more logical channels;
page length for complex RF data sample pages;
start of page indicator; and
enablement and disablement of call processing software logical channel reconfiguration instructions.

47. The system of claim 46, wherein call processing software logical channel reconfiguration instructions include one or more of:
frequency hopping instructions;
bandwidth allocation instructions;
protocol reconfiguration instructions; and
signal gain adjustment instructions.

48. The system of claim 46, wherein the logical channel RF parameters include one or more of modulation protocol, radio frequency, bandwidth allocation, and signal gain.
